(19) United States
(12) Patent Application Publication
(10) Pub. No.: US 2007/0292823 A1
(43) Pub. Date: Dec. 20, 2007

(54) System and method for creating, assessing, modifying, and using a learning map

(75) Inventors: Sylvia Tidwell Scheuring, Carmel, CA (US); Richard James Lee, Aptos, CA (US); Brad Hanson, Monterey, CA (US); Bruce A. Hanson, Phoenix, AZ (US); Roger P. Creamer, Pacific Grove, CA (US)

Correspondence Address: ROTHWELL, FIGG, ERNST & MANBECK, P.C., 1425 K STREET, N.W., SUITE 800, WASHINGTON, DC, 20005, US

(73) Assignee: CTB/MCGRAW-HILL, Monterey, CA (US)

(21) Appl. No.: 11/842,184

(22) Filed: Aug. 21, 2007

Related U.S. Application Data
(62) Division of application No. 10/777,212, filed on Feb. 13, 2004.
(60) Provisional application No. 60/447,300, filed on Feb. 14, 2003.
(60) Provisional application No. 60/449,827, filed on Feb. 26, 2003.

(51) Int. Cl. G09B 19/00

(52) U.S. Cl. 434/118

(57) ABSTRACT

An embodiment of the invention provides a system and method for creating a learning map, which is a device for expressing hypothesized learning target dependencies within any domain of knowledge of skill acquisition. The system and method are also able to utilize multiple data types and sources to assess whether the learning target dependencies expressed by a learning map are accurate and are configured to modify the learning map as necessary so that the learning map conforms to the reality of how students learn.

This application is a divisional of U.S. application Ser. No. 10/777,212, filed Feb. 13, 2004, pending, which claims the benefit of U.S. Provisional Patent Application Nos. 60/447,300, filed Feb. 14, 2003 and 60/449,827, filed Feb. 26, 2003, and each of the forgoing applications is incorporated herein by this reference.

### BACKGROUND OF THE INVENTION

1. Field of the Invention

The present invention relates to field of education, and, more specifically, provides systems and methods for creating, assessing, and modifying a learning map, which is a device for expressing probabilistic dependency relationships between and amongst learning targets, misconceptions, and common errors associated with learning targets.

2. Discussion of the Background

In the field of education, it is important to have an understanding of the dependency relationship between academic content areas as well as the dependency relationship between concepts and skills within an academic content area for various groups of students. For example, from an educator's point of view, it is beneficial to know that, for a certain group of students, a given academic content area (e.g., calculus) is dependent on another academic content area (e.g., algebra). Similarly, it is beneficial to know that a given concept (e.g., multiplication) is dependent on another concept (e.g., addition).

By saying that a first concept or content area (hereafter “learning target”) is “dependent” on a second learning target we mean that, if a student does not have an understanding of the second learning target, then there is a low probability that the student has, or will be able to obtain, an understanding of the first learning target. For example, if we assert that multiplication is dependent on addition, we are asserting that it is unlikely a student would understand multiplication if the student does not understand addition. In other words, we are asserting that it would be highly likely a student understands addition, if the student demonstrates an understanding of multiplication.

By having an accurate picture of the dependencies between learning targets at varying levels of specificity, from entire domains of knowledge and skill to the smallest targetable concepts and skills within domains, educators can construct efficient knowledge assessments. For example, assuming that multiplication is dependent on addition, an educator who wants to efficiently assess whether a student has mastered both addition and multiplication may need only test the student's understanding of multiplication. This is so because the dependency relationship between addition and multiplication tells us that if the student understands multiplication, then there is a high probability that the student also understands addition. Thus, when a student shows an understanding for multiplication, there is little need to test the student's understanding of addition.

Additionally, an accurate picture of the dependency relationship between learning targets enables educators to better design courses and curriculums. For example, from an understanding of learning target dependencies, an educator knows that students have a relative low probability of grasping a particular learning target (e.g., multiplication of positive, whole numbers) if the students do not first grasp the learning target(s) on which the particular target depends (e.g., addition).

What is desired, therefore, is a system and method for expressing hypothesized learning target dependencies and for assessing whether the hypothesized learning target dependencies are accurate.

### SUMMARY OF THE INVENTION

The present invention provides such a desired system and method. That is, an embodiment of the invention provides a system and method for creating a learning map, which is a device for expressing hypothesized learning target dependencies. The system and method are also able to assess whether the learning target dependencies expressed by a learning map are accurate and to modify the learning map as necessary so that the learning map conforms to the reality of how students learn, or how different sub populations learn.

In one aspect, the system enables a user to define learning targets and the probabilistic relationships between them. These learning target definitions, combined with the probabilistic relationships, form a learning map. One or more types of relationships between learning targets may be used. One necessary relationship is the probabilistic order in which the learning targets are mastered. For example, a first learning target could be a precursor to a second learning target. Additionally, the first learning target could be a postcursor to (learned after) a third learning target. Similarly, the second and third learning targets could have pre/post-cursor relationships with other learning targets. Using these relationships, the targets are structured into a network of targets (or nodes), in an acyclic directed network such that no node can be the precursor or postcursor of itself either directly or indirectly. In one embodiment, when a first learning target is a precursor of a second learning target, it implies that the knowledge of the second learning target is dependent on the knowledge of the first learning target.

The order of the targets in the learning map is such that if there is a path between the two learning targets, there may be one or more additional paths between them. These paths may be mutually probabilistically exclusive (i.e., if a learner progresses through one path, they are not likely to progress through another), they may be mutually probabilistically necessary (i.e., a learner is likely to need to progress through all of the paths), or only some subset of the paths may be necessary (i.e. if a learner goes though a given path, he/she is likely to go through some other path as well). These probabilities of path traversal may be expressed as Boolean or as real numbers.

Advantageously, the system can determine the accuracy of a learning map based on item response information provided to the system. The system can be configured to determine the accuracy of the learning map for all learners in given set or for one or more subsets of the learners using whatever criteria for set membership is desired. Multiple learning maps, each calibrated by the data stream from test administrations to variations in the learning sequence and targets of different subpopulations, can be maintained simultaneously and compared or used separately. Students might be associated with more than one learning map, for example a student who is gifted and female might be associated with both a map based on a gifted population and a map based on a female population.

The adaptive system can utilize evaluations of the learning map by subject matter experts (SMEs) and/or by feedback from users to determine the accuracy of the learning map target definitions, relationship probabilities, and path probabilities.

The system also may utilize responses to assessments and/or evaluation of the learner by themselves and/or others to evaluate the accuracy and usefulness of the learning map in learning as well as providing evidence used to find more optimal target definitions or relationship probabilities for all learners in the system or for one or more subsets of the learners. When the system determines that a more optimal path exists, it modifies the learning progress map network definition accordingly. The system can make optimization modification to the learning map automatically, or can be set to ask for approval prior to modification. All modifications whether done with or without approval can be rolled back to a previous learning map state. Various algorithms may be used to determine an improved structure of the map.

Benefits of the present invention include: increasingly accurate, empirically based, and continually updated mapping of learning order relationships in any domain of knowledge and for any population or sub-population of learners, increasing ability to assist learners in learning various targets by accurately identifying the likelihood of various targets as being precursor targets to help facilitate learning one or more chosen learning target(s); increasingly accurate and efficient adaptive assessment of which learning targets have been learned by a student or set of students can be facilitated based on identification of target-target relationships; increasingly useful ordering of instructional sequencing and/or content such as content within textbooks and software or other instructional materials as the relationships between targets of learning are better known; increasingly beneficial backward hyperlinking to precursor content associated with target content as well as forward linking to content associated with postcursor content; increasingly accurate comparisons between the learning map or maps and institutional curriculum frameworks; increasingly useful evaluation of instructional materials and techniques; increased understanding of learning paths for various groups of students; improved test reliability and validity when the system is applied to either formative or summative testing programs; accelerated rates of learning when the system is applied to assessment and/or instructional programs; enhanced ability to communicate the content of instruction and the results of assessment to a variety of audiences, including students, parents, teachers, and administrators.

The systems based on the present invention can serve as the foundation for new kinds of educational services, such as diagnostic testing of student achievement and fine-grained evaluation of the effectiveness of instruction, new paradigms for assessing achievement, aptitude and intelligence using hitherto uncollected and unanalyzed types of learning data such as time-to-learn, new modes of accelerated learning based on progressive minimization of the time gap between a learner's incorrect or partially correct response and accurately targeted, corrective feedback from a responsive learning environment. The quality of these services, however, can only be as good as the alignment between the learning maps created by the system and the reality of how students learn (where students or learners include individuals or groups of individuals who learn anything, whether formally or informally, with or without their knowledge). Preferably, this alignment is continuously improved using the data from test administrations as well as a community process, which may be moderated (including users and subject matter experts) as input into the adaptive system. In this sense, one can create a system that is self-learning, or adaptive. With this adaptivity, the system self-corrects errors in initial hypotheses about stages of learning in each content area and calibrates itself on an ongoing basis to changes in knowledge, curriculum, and instruction, or any other factor that can influence learning maps.

The above and other features and advantages of the present invention, as well as the structure and operation of preferred embodiments of the present invention, are described in detail below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements. Additionally, the left-most digit(s) of a reference number identifies the drawing in which the reference number first appears.

FIG. 1 illustrates a process, according to one embodiment of the invention, for creating a learning map.

FIG. 2 illustrates a conditional probability table (CPT), according to one embodiment.

FIG. 3 illustrates a learning map.

FIG. 4 illustrates a learning map with a goal node.

FIG. 5 illustrates a learning map with items and learning materials linked to a learning target

FIG. 6 diagrams an example of a student response pattern for an example learning map.

FIG. 7, illustrates a learning path.

FIG. 8 illustrates a modified learning map

FIG. 9 illustrates database tables that may used by a student evaluation system according to one embodiment.

FIG. 10 illustrates a process, according to one embodiment of the invention.

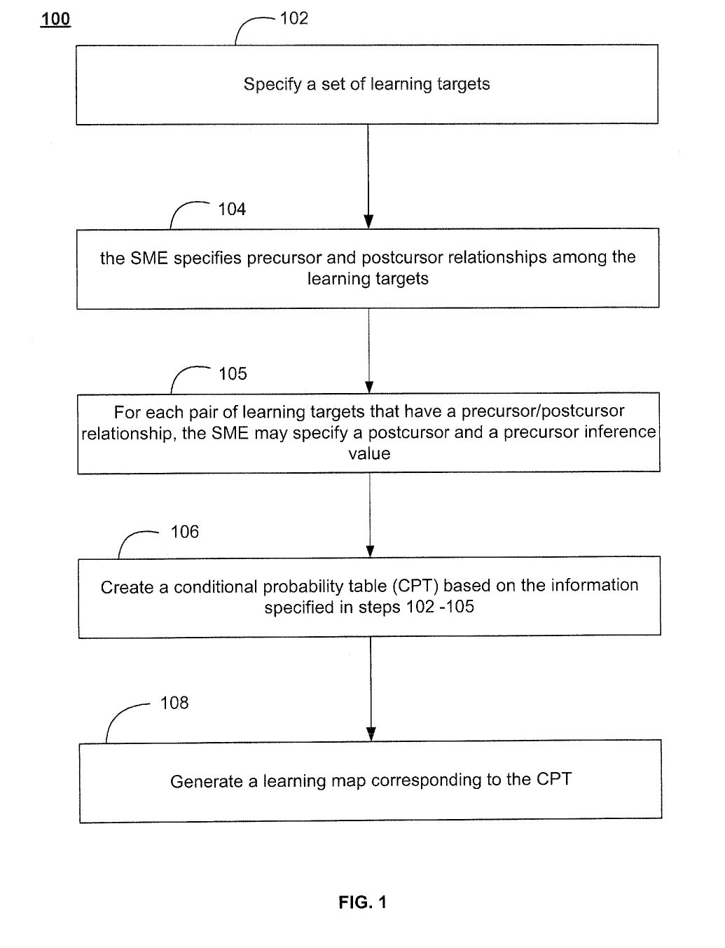

FIG. 1 illustrates a set of interconnected learning targets.

FIG. 12 illustrates an example student test responses table.

FIG. 13 illustrates an example response-effects table.

FIG. 14 illustrates an example student/learning target table.

FIG. 15 is a block diagram of an example computer system.

FIG. 16 is a flowchart illustrating a process, according to one embodiment, for determining the postcursor and precursor inference values for a postcursor/precursor learning target pair.

FIG. 17 is a network diagram illustrating precursor inference values.

FIG. 18 is a network diagram illustrating postcursor inference values.

FIG. 19 is a diagram illustrating an inference model

FIG. 20 is a more detailed diagram illustrating the inference model.

FIG. 21 shows an example individual student map.

### DETAILED DESCRIPTION OF THE PREFERRED EMBODIMENTS

While the present invention may be embodied in many different forms, there is described herein in detail illustrative embodiments with the understanding that the present disclosure is to be considered as an example of the principles of the invention and is not intended to limit the invention to the illustrated embodiments.

The present invention provides a system, method, and computer program product for creating, modifying and utilizing a learning map, which is an acyclic directed network that expresses learning target dependency relationships.

FIG. 1 illustrates a process 100, according to one embodiment of the invention, for creating a learning map. In step 102, a user, preferably a subject matter expert (SME), specifies a set of learning targets. For example, the SME may create a list of learning targets and input the list into a computer system.

In step 104, the SME specifies precursor and postcursor relationships among the learning targets. Each learning target has at least one precursor learning target or at least one postcursor learning target (each learning target, however, may have both precursor and postcursor learning targets). Accordingly, in step 104, the SME may, for each learning target, specify the learning targets that are postcursors or precursors of the learning target. As an example, the SME could specify that the third learning target is a postcursor of the second learning target.

For each pair of learning targets that have a precursor/postcursor relationship, the SME may specify a postcursor and a precursor inference value (step 105). A postcursor inference value is a value that represents the probability that a student knows the precursor learning target if it can be shown that the student knows the postcursor learning target. A precursor inference value is a value that represents the probability that a student does not know the postcursor learning target if it can be shown that the student does not know the precursor learning target.

In step 106, a conditional probability (CP) table may be created based on the input received from steps 102, 104 and 105. The CP table captures the relationships among the learning targets and the pre/postcursor inference values.

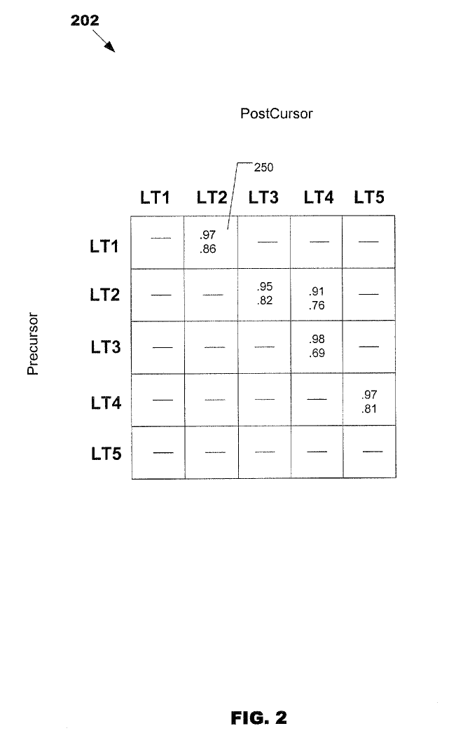

FIG. 2 illustrates an example CP table 202, according to one embodiment. As shown in CPT 202, we can determine that five learning targets (LT1, LT2, . . . , LT5) have been specified in step 102 because there are five rows in the CPT 202. Each row in CPT 202 corresponds to a unique one of the five learning targets. The data in a given row specifies the postcursor relationships between the learning target corresponding to the given row and the other learning targets.

For example, consider the first row of CP table 202. This row corresponds to learning target LT1. The data in this row indicates that LT2 is the only learning target that is a postcursor of LT1 because cell 250, which corresponds to LT2, includes the precursor and postcursor inference values, whereas all the other cells in the row do not contain inference values. The inference values included in cell 250 indicates that, if a student doesn't know LT1, then there is a probability of 0.86 that the student also does not know LT2, and if a student knows LT2, then there is a probability of 0.97 that the student also knows LT1.

The second row in CP table 202, which corresponds to LT2, indicates that LT3 is the only learning target that is a postcursor of LT2. This row also indicates that, if a student doesn't know LT2, then there is a probability of 0.82 that the student also does not know LT3, and if a student knows LT3, then there is a probability of 0.95 that the student also knows LT2.

In step 108, CP table 202 can be used to generate a network diagram that corresponds to CP table 202. The network diagram has nodes and arcs, wherein the nodes represent the specified learning targets and the arcs represent the specified postcursor relationships between learning targets. This network diagram forms a learning map. Learning maps are advantageous in that they can be used to generate efficient tests (i.e., knowledge assessments) that assess one's knowledge of a particular academic content area or across multiple academic areas. Other advantages also exist.

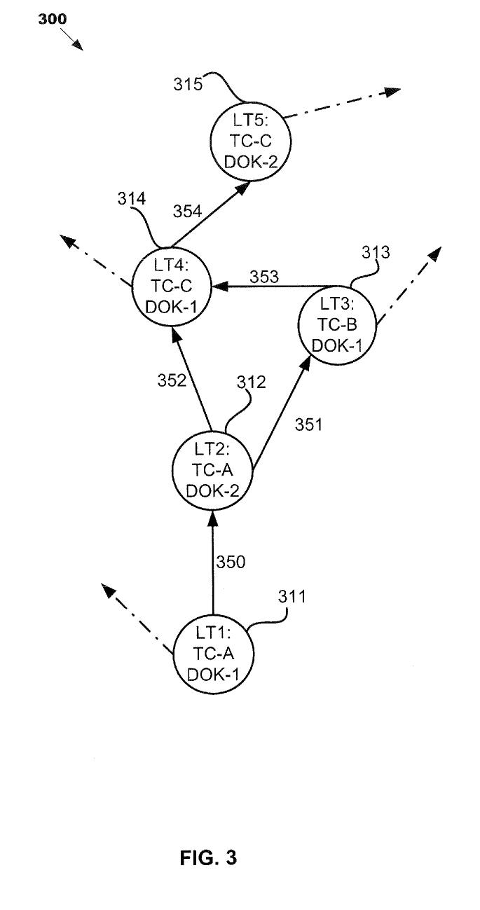

FIG. 3 illustrates the learning map 300 that corresponds to CP table 202. As shown in FIG. 3, learning map 300 includes a set of nodes 311-315, which represent learning targets LT1-LT5, respectively. Learning map 300 also includes arcs 350-354, which illustrate the learning target postcursor/precursor relationships. The dashed arcs represent that map 300 can be part of a larger map. Preferably, the learning maps are directed, acyclic graphs. In other words, the arcs go in only one direction and there are no cyclic paths within the map.

In one embodiment, each learning target represents or is associated with a smallest targeted or teachable concept (TC) at a defined level of expertise or depth of knowledge (DOK). A TC can include a concept, knowledge state, proposition, conceptual relationship, definition, process, procedure, cognitive state, content, function, anything anyone can do or know, or a combination of any of these. A DOK is a degree or range of degrees of progress in a continuum over which something increases in cognitive demand, complexity, difficulty, novelty, distance of transfer of learning, or any other concepts relating to a progression along a novice-expert continuum, or any combination of these.

For example, learning target 311 (LT1) represents a particular TC (i.e., TC-A) at a particular depth of knowledge (i.e., DOK-1). Learning target 312 (LT2), represents the same TC as learning target 311, but at a different depth of knowledge. That is, learning target 312, represents TC-A at a depth of knowledge of DOK-2. Arc 350, which connects target 311 to 312, represents the relationship between target 311 and 312. Because arc 350 points from target 311 to target 312, target 311 is a precursor to target 312, and target 312 is a postcursor of target 311.

The knowledge that may be covered in a learning map of the invention can include, but is not limited to, all concepts covered in the four major subject areas, English/Language Arts, Mathematics, Science and Social Studies in grades K-12 for all states in the United States. These four major subject areas are defined in terms of knowledge taught at given grade ranges, though some other breadth definition may be used. Other embodiments could include individually acquired knowledge, or knowledge taught in kindergarten through high school, preschool, junior college, four year college, graduate schools, professional development or vocational programs, instructional web sites and/or any other time range or age boundaries desired, and/or for a single school, a district, a state, a country, multiple countries, any other institutional or geographic boundaries desired, and/or may be specific to the requirements for a single goal, such as the knowledge requirements for building a bridge or planning a dinner party, or multiple goals, or any other content boundaries desired.

In addition to representing a TC at a particular DOK, a learning target can represent a misconception. Misconceptions permit the mapping of actual rather than idealized knowledge states of individuals and/or groups. Knowledge states of individuals consist of a mixture of misconceptions and correct conceptions. Misconceptions might more accurately be referred to as limited conceptions or partially correct conceptions, and correct conceptions might more accurately be referred to as less limited or more correct conceptions—the point being that in the development of expertise, a learning path often transitions from conceptions that are correct in some respects but not others to conceptions that provide better fit to the data or closer approximations to reality. The partially correct conceptions can be both obstacles and bridges to acquiring the more correct conceptions, both enablers and disablers of postcursor knowledge. The ability to assess and alter the knowledge states of individuals and groups is greatly enhanced by including in the learning maps these often useful and, in some ways, correct transitional knowledge states, which are ignored in most knowledge frameworks (e.g. state educational standards documents).

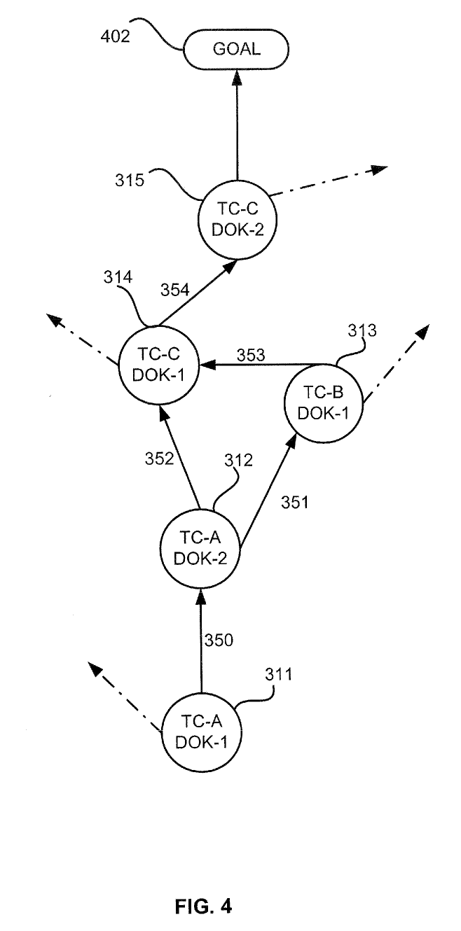

In some embodiments, in step 102, goals as well as learning targets are specified by the SME. In embodiments where goals are specified, goal nodes are included the learning map. FIG. 4 illustrates a learning map with a goal node 402. Goal nodes are used to represent some target of attainment (e.g., “congratulations, you now possess all knowledge pre-requisites for a carpenter, entry level”).

Goal nodes are likely to be linked to multiple precursor nodes. The benefits of these goal nodes include: various reports to educational institutions regarding the relevance of their curriculum to real-world jobs, student achievement vs. these goals, etc; (b) reports to individuals to assess their readiness for one or more specific goals; (c) discovery of readiness for jobs that the individual might not have thought about, (d) cost/benefit analysis for pursuing various goals, where “cost” could be a time to learn prediction and “benefit” could be salary expectations. Additionally, students don't always understand the need to learn certain subjects or skills, since they may not perceive the benefit for potential career goals. This invention may be used to provide a basis for visualization of these relationships.

In addition to the learning target nodes and goal nodes, a learning map may include structural nodes. Structural nodes are used to specify the probabilities of alternate paths through the network, e.g., whether or not a student should complete both paths in the network prior to attempting the postcursor node to which they both lead. For example, in situations where more than one learning path can result in successful entry to a node, the structural node can carry a probabilistic “OR” relationship: that either node “A” OR node “B” are precursors to node “C”. However, it might also be true that in such cases if both “A” and “B” are completed, then time to complete “C” or some subsequent node might be reduced.

Another possibility: “A” OR “B” might be sufficient for “C”, but both might be pre-requisites for “C2” (same TC as “C”, but at a greater DOK). If both of these possibilities are true, then it might be more efficient to teach both “A” and “B” before “C”. Use of structural nodes to retain this type of information helps to design optimized curriculum frameworks, and facilitate optimization of instructional time.

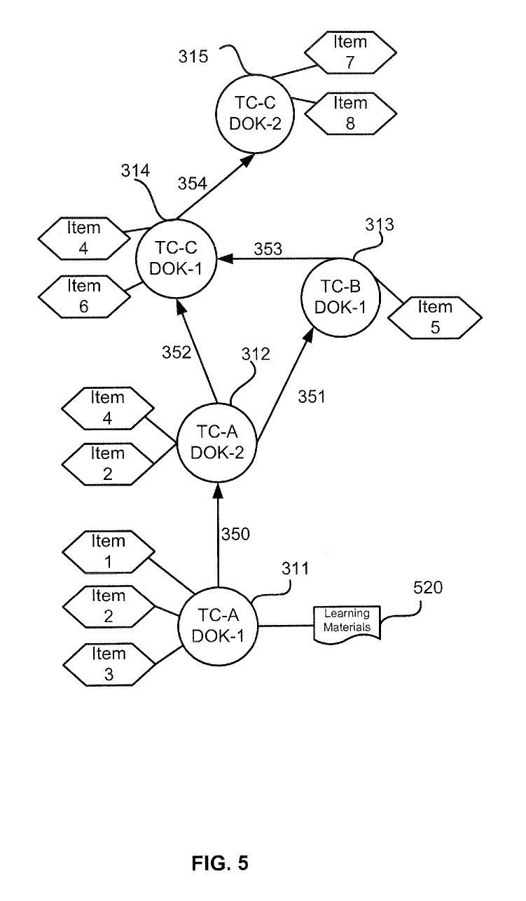

Preferably, each learning target 311-315 is linked (associated) with a set of one or more assessment items. Additionally, a learning target 311-315 may be linked with learning materials corresponding to the learning target. This is illustrated in FIG. 5. As shown in FIG. 5, each learning target is linked with one or more items and/or one or more learning materials. As also shown in FIG. 5, a particular item may be linked with more than one learning target. For example, learning target 311 is linked with three items, items 1-3 and with learning materials 520, and learning target 312 is linked with item 2 and item 4. Preferably, a learning target is only linked with items that target the learning target. In other words, preferably, a learning target is linked with only those items that are useful in assessing whether or not a learner knows the learning target. The learning materials may include links (e.g., uniform resource locators (URLs)), or other types of digital links, to other learning materials.

An item is an assessment unit, usually a problem or question. An item can be a selected response item, constructed response item, essay response item, performance assessment task, or any other device for gathering assessment information. Items can be delivered and or scored via a manual process or via electronic process e.g., CDROM, web pages, computer program on any electronic and/or optical devices, e.g., optical scanner, optical computer, PDA, cell phone, digital pen-based systems, electronic hand-scoring, traditional paper and pencil, or any other delivery technique, network or technology. The same item could also be a member of the set of items linked to any learning target based on the probability that the stem and incorrect responses or response patterns to the item or score ranges on an item target the TC at the given DOK indicated by that target. It is important to note that any stimulus-response pair or response pattern to an item or score range on an item can target more than a single node. This is to account for the fact that an item may test more than a single conception (such as a math item that requires the student to read). Different stimulus-response pairs or response patterns to an item or score range on an item may also target different nodes.

The precursor/postcursor relationship between learning targets is important because they provide information concerning the sequence in which learning targets should be taught to students. For example, a student should not attempt to learn a given learning target unless and until the student has mastered the necessary precursor learning targets. As a concrete example, consider learning target 312. As discussed above, learning target 311 is precursor to learning target 312. Because the only way to get to learning target 312 is via arc 350, which connects target 311 to target 312, learning target 311 is considered a necessary precursor to target 312. That is, a student should not attempt to learn learning target 312, before having mastered learning target 311.

As another concrete example, consider learning target 314. As illustrated in map 300, learning target 314 has two precursor learning targets (learning target 312 and 313). In one embodiment, this means that there are two possible paths that can be taken to reach target 314. That is, a student should learn either target 312 or target 313 prior to learning target 314.

Another important aspect of the precursor/postcursor relationship between learning targets, is that they enable one to draw inferences concerning a student's knowledge of a learning target. For example, if there was no direct evidence as to whether a student knows learning target 311, but there was evidence that the student knows learning target 312, then we can infer that there is a probability of 0.97 that student knows learning target 311, assuming, of course, that the inference value in CP table 202 is correct.

This ability of the learning map (and CP table 202) to enable an educator to make inferences about a student's knowledge of a given learning target is valuable. Among other things, it enables the educator to create efficient assessment tests. For example, an educator who wants to efficiently assess whether a student has mastered learning target 311 and learning target 312, may need only test the students understanding of learning target 312. This is so because the dependency relationship between learning target 311 and learning target 312 tells us that if the student understands learning target 312, then there is a high probability that the student also understands learning target 311. More specifically, according to the postcursor inference value associated with learning target pair 311 and 312, there is a probability of 0.97 that the student knows learning target 311 if the student has demonstrated comprehension of learning target 312. Thus, when a student demonstrates an understanding for learning target 312, there is little need to test the student's understanding of learning target 311.

FIG. 19 is a diagram illustrating an inference model. FIG. 19 shows a learning target 1902 (a.k.a., “the target”), a postcursor 1904 of the target, and a precursor 1906 of the target. As shown in the model, knowledge of the target 1902 is implied by knowledge of the postcursor 1904. Thus, there is an implication relationship between the target 1902 and the postcursor 1904. Similarly, there is a causation relationship between the target 1902 and the precursor 1904. That is, a student doesn't know the target because the student doesn't know the precursor. FIG. 19 also shows two responses to an item: response A and response B. Each response has a demonstration relationship with the target. That is, if the student selects response A, then this demonstrates knowledge of the target, whereas if the student selects response B, this demonstrates that the student doesn't know the target.

FIG. 20 is a specific instance of the inference model shown in FIG. 19. In FIG. 20, the target learning target is “subtraction no regrouping,” the postcursor is “addition regrouping,” and the precursor is “addition no regrouping.” As shown in FIG. 20, if a student demonstrates knowledge of the postcursor, then there is a 0.987 probability that the student knows the target. Similarly, if the student demonstrates that he does not know the precursor, then there is a probability of 0.84 that the student also does not know the target. FIG. 20 also shows an item. The item asks a student to subtract 12 from 27. The probability values associated with the various responses to the item can be used to calculate the probability that the student knows or doesn't know the target. For example, if in response to the item a student responds with “17,” then there is a probability of 0.92 that the student has not mastered the target.

As discussed above with respect to FIG. 1, it was mentioned that the SME may input a postcursor and a precursor inference value for each postcursor/precursor learning target pair.

FIG. 16 is a flowchart illustrating a process 1600, according to one embodiment, for determining the postcursor and precursor inference values for a postcursor/precursor learning target pair, such as, for example postcursor/precursor learning target pair LT1 and LT2 shown in FIG. 3, using assessment data.

Process 1600 may begin in step 1602, where a set of students (preferably a relatively large number of students) are assessed to determine the knowledge state of each student in the set with respect to the learning targets that form the postcursor/precursor learning target pair. For example, each student in the set is assessed to determine whether the student knows or doesn't know learning target LT1 and whether the student knows or doesn't know learning target LT2.

In step 1604, those students for whom it was not possible to determine the student's knowledge state of both learning targets that make up the pair are removed from the set. For example, if a student's response to a first item in an assessment indicates the student knows LT1, but the student's response to a second item indicates that the student does not know LT1, then there is conflicting evidence and it is not possible to determine with a degree of accuracy whether or not the student knows or doesn't know LT1. Accordingly, in step 1604, this student would be “removed” from the set.

In steps 1606-1610 the precursor inference value for the pre/postcursor learning target pair is determined and in steps 1612-1616 the postcursor inference value for the pair is determined.

In step 1606, the number of students remaining in the set who have demonstrated that they do not know the precursor learning target (learning target LT1 in our example) is determined. In step 1608, the number students remaining in the set who have demonstrated that they do not know both the precursor learning target (LT1) and the postcursor learning target (LT2) is determined. In step 1610, the precursor inference value is determined by dividing the number determined in step 1608 by the number determined in step 1606. As a concrete example, if there are 100 students remaining in the set after step 1604 and 75 of these 100 students have been determined to not know LT1 and 50 of these 100 students have been determined to not know both LT1 and LT2, then the precursor inference value for the pre/postcursor pair LT1->LT2 is 50/75=⅔=66%. Accordingly, we can say with some degree of certainty that if a student does not know LT1, then there is a probability of 0.66 that the student does not know LT2.

FIG. 17 illustrates an example Math Computation precursor inference network diagram 1700 having learning targets A-H2. The diagram 1700 is instructive because it displays the precursor inference values for each pre/postcursor learning target pair. For example, the precursor inference value for learning target pair A (addition no regrouping) and E (addition regrouping) is 0.84.

Referring back to FIG. 16, in step 1612, the number students remaining in the set who have demonstrated that they know the postcursor learning target (learning target LT2 in our example) is determined. In step 1614, the number students remaining in the set who have demonstrated that they know both the precursor learning target (LT1) and the postcursor learning target (LT2) is determined. In step 1616, the postcursor inference value is determined by dividing the number determined in step 1614 by the number determined in step 1612. As a concrete example, if there are 100 students remaining in the set after step 1604 and 50 of those students have been determined to know LT2 and 45 of those students have been determined to know both LT1 and LT2, then the postcursor inference value for the pre/postcursor pair LT1->LT2 is 45/50= 9/10=90%. Accordingly, we can say with some degree of certainty that if a student demonstrates knowledge of LT2, then there is a probability of 0.90 that the student has mastered LT1.

FIG. 18 illustrates an example Math Computation postcursor inference network diagram 1800 having learning targets A-H2. The diagram 1800 is instructive because it displays the postcursor inference values for each pre/postcursor learning target pair. For example, the postcursor inference value for learning target pair A (addition no regrouping) and E (addition regrouping) is 0.997.

It is important to note, however, that before an educator uses a learning map to make inferences about a student's knowledge, the learning map should first be assessed for its accuracy or empirically verified. Preferably, the learning map should be continuously assessed as new data becomes available from various assessment products.

In addition to method 1600, a number of other methods may be used to test the validity of learning map against a set of field test data. Some of these methods are significantly more computationally intensive than others, but the more CPU intensive approaches may yield more accurate evaluation of the network structure of the learning map.

In general, the learning map can be validated based on the relationship between items linked to nodes of the learning map. If statistical analysis of the relationships between the items linked to a node and across nodes is consistent with the relationship predicted by the structure of the learning map, then the leaning map is considered to be valid.

A fairly CPU friendly method for defining precursor relationship between items is described by Philip M. Sadler (see “The Relevance of Multiple Choice Tests in Assessing Science Understanding,” Assessing Science Understanding: A Human Constructivist View,

San Diego Academic Press, 2000). This method described by Sadler is a purely statistical approach in which the percentage of correct responses to one item is compared with the percentage of correct responses to another item. The computational requirement of this approach is relative to the square of the items to be evaluated. For a set of 50 items 2500 comparisons will be made. “Item X” is defined as likely to be a precursor to “Item Y” if the percentage of students who respond correctly to “Item X” is greater than the percentage of students who respond correctly to “Item Y”. There are, however, two significant limitations with this approach. One is that statistical relationships can exist between items that have no actual cognitive relationship to one another. Another is that the set of students that answered “Item Y” correctly may not be an exact overlap with the set of students who answered “Item X” correctly.

The present invention, which forms and orders a learning map to represent knowledge states or concepts based on the logic and theory of stages of cognitive development, rather than forming the nodes of the network around items that behave in similar ways statistically, provides an initial foundation of cognitive coherence that a purely statistically derived framework will lack. The learning map, which is structured by initial conceptual ordering, can be refined empirically based on a data stream from field tests and operational administrations. For some embodiments, as discussed above, a set of items is associated with each node in the learning map. Test data from administration of these items can be used to identify and reject or correct items that do not accurately target the nodes. More fundamentally, the test data can also reveal poor node placement in the network structure; this is the basis for the self-learning aspect of the learning map system.

Whether the evidence is from item responses or other sources, if the test data or other evidence is frequently inconsistent with the learning map's predictions, the method seeks to determine if the source of the inconsistency is the evidence or the structure of the learning map. When the majority of the evidence is consistent with the structure, the reliability of inconsistent evidence is reduced. In the case of inconsistent evidence provided by stem-response pairs from assessments, the stem-response membership in the set testing that node is reduced. In the case of evidence provided by individuals, the reliability of all information provided by the individual is examined to determine how much to reduce the reliability of this individual's input of evidence into the nodes for which they have provided inconsistent information (this process would apply for SME, teacher evaluation, student self evaluation, community input, hand-scoring, etc).

If the source (or part of the source) of the inconsistency appears to be with the predictions provided by the structure of the learning map, then modifications to the structure of the learning map are postulated to bring the predictions of the learning map more closely in alignment with the evidence. Changes to the structure include adding nodes, removing nodes, splitting nodes, combining nodes, adding arcs, removing arcs, changing the probability in the conditional probabilities for the arcs, etc. Any of these changes in structure may result in changes to the probability of set membership of evidence (including stem-response pairs, etc) in the nodes. Note that in the case of addition of new nodes, the evidence may continue to be a set member of the nodes with which it was previously a set member in addition to the new node or nodes, though the probability of set membership with previous nodes may change. The reviewers of this proposed change will have access to the previous Learning map structure as well as the proposed structure, and the differences between them, to evaluate whether or not to accept the proposed changes, and to assist with aiding in determining the semantic meaning (TC-DOK definition) of the new nodes.

If the evidence indicates that a node is really behaving like two or more nodes (within some parameter that can be set in the system), then the system implementing the technique preferably postulates the number of nodes suggested by the behavior, creates a set of evidence probability (evidence, reliability) tuples that maximizes the probability of association with each postulated node, determine likely arcs to and from the new node and the probabilities for the each of the conditional probabilities for these arcs, then generates a request for review and revised semantic definitions of the new node or nodes.

If the evidence indicates that one or more nodes is behaving nearly identically (within some parameter that can be set in the system), then the system preferably postulates combination of the nodes, and generates a request for proposed structural changes and revised semantic definition of the new node.

If pieces of evidence from various nodes imply that there should be one or more nodes that do not currently exist (note that the splitting of a node is a special case of this type of modification—where all of the evidence for the new node is contained in a single node), then the system preferably postulates the node or nodes, and defines set membership of the evidence implying its existence with the appropriate node. The system then generates a request for review of proposed structural changes and revised semantic definition for the new node or nodes.

Various techniques can be used to identify inconsistencies in evidence, and to postulate changes in the Learning map structure. Such techniques include: Student-by-Student Item Path Analysis (SIPA), Student-by-Student Evidence Path Analysis (SEPA), Monte Carlo Markov Chaining (MCMC), Latent Trait Analysis, Factor Analysis, Item Response Theory (IRT), Multi-Dimensional Item Response Theory (MIRT), Simulated Annealing, Hill-climbing, etc., either singly or in any combination.

The Student-by-Student Item Path Analysis (SIPA) mentioned above is one preferred technique. SIPA is significantly more CPU intensive than Sadler's method, but is not limited by the likelihood of an incomplete overlap between sets of students who respond correctly to different items. For SIPA, all possible item paths through the network are defined and traced through separately for each student in order to determine the validity and reliability of the learning map structure (arc relationships) as well as the definition of nodes within it. The computational requirement for this approach is a function of the number of paths through each of the stimulus-response pairs (response) or pieces of item evidence associated with nodes in the network multiplied by the number of students.

In one embodiment of SIPA, all of the possible multiple paths through each potential item response associated with a node or nodes in a learning map are automatically defined. These paths are constructed automatically from the map by determining the “fundamental” responses in the map, i.e., the responses associated with nodes that have no precursors. From the fundamental responses, paths were traced through each combination of items associated with the post-cursor relationships between nodes.

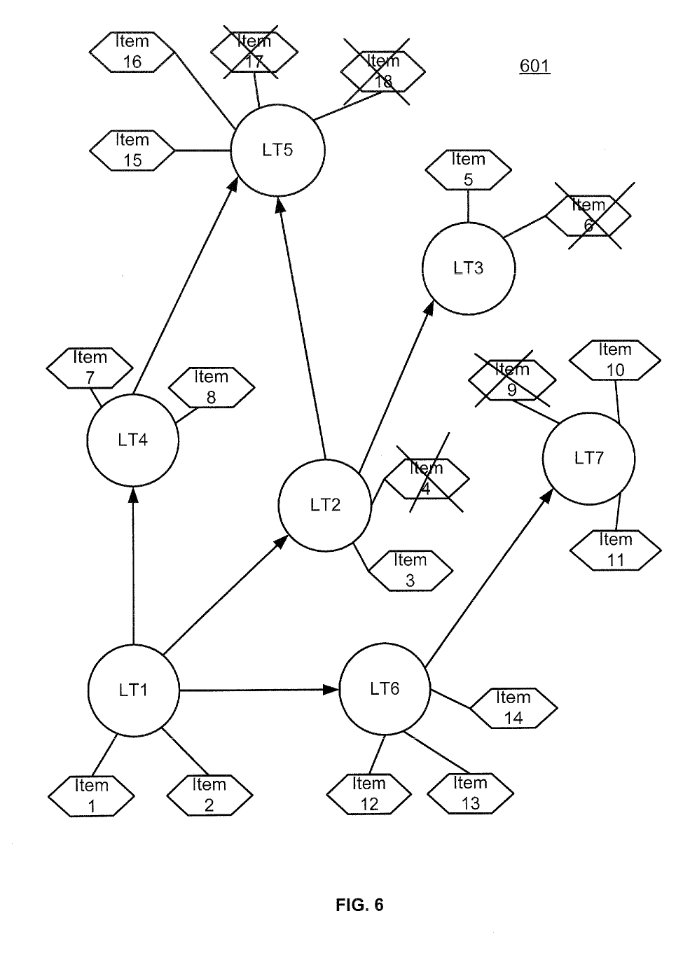

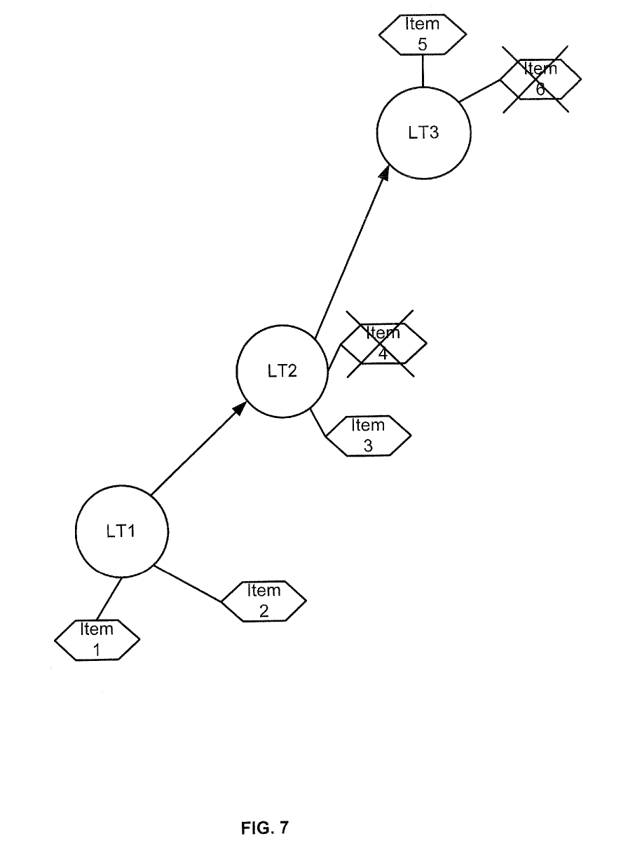

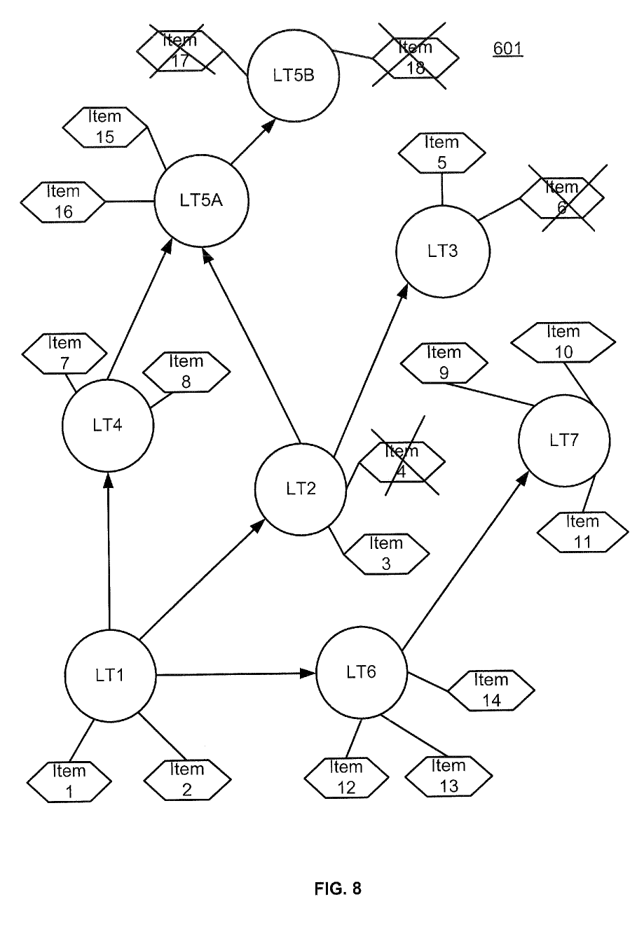

FIG. 6 diagrams an example of a student response pattern for an example learning map 601. As illustrated in FIG. 6, learning map 601 includes learning target nodes LT1-LT7. Each node is associated with one or more items. For example, node LT1 is associated with items 1 and 2. An X in through an item indicates that the student provided an incorrect response to the item. Thus, as shown in FIG. 6, the student provided an incorrect response to items 4, 6, 9, 17, and 18.

FIG. 7, illustrates one path included in learning map 601. A path, is, in essence, a representation of one means by which a student might come to understanding of each of the node combinations along that particular path: for example in FIG. 7, one's mastery of learning target LT1 (e.g., addition of whole numbers without regrouping) might precede one's mastery of learning target LT2 (e.g., addition of whole numbers with regrouping), which in turn might precede one's mastery of learning target LT3 (e.g., multiplication of whole numbers without regrouping), and so on.

If the student's response to a target item is correct, then one would expect that the student would have responded correctly to all items associated with nodes considered to be precursors to the target item's node. To determine the accuracy of our expectation, the target item's predecessors are examined and points are accumulated for the target item based on the student's responses to the predecessor items. For each response to a predecessor item that is consistent with the response to the target item the target item is given +1 point. For each response to a predecessor item that is inconsistent with the response to a target item, the target item is given −1 point.

For example, examine the response pattern in FIG. 7. For this example, assume item 3 is the target item. As shown in FIG. 7, item 3 was answered correctly. We therefore examine its precursor items (i.e, items 1 and 2) rather than its postcursor items (items 5 and 6). Since both precursors were consistent with a correct response to the target item, i.e. the student answered both items 1 and 2 correctly, the target item 3 receives a score of +2 for this student for the path shown in FIG. 7.

If the student's response to the target item was incorrect, then one would expect the student responded incorrectly to all items associated with nodes considered to be postcursors to the target item's node. To determine the accuracy of our prediction, the item's successors are examined. For each successor item that was consistent with the response, i.e., the successor response was also incorrect, the item is assigned +1 point for this student and for this path. For each successor that is inconsistent with the response, the item is assigned −1 point for this student and for this path.

In the path of FIG. 7, item 4 was answered incorrectly. We therefore examine its successor items (items 5 and 6) in turn. Since the response to item 5 was inconsistent with the incorrect response to Item 4 (i.e. the item was answered correctly by the student), item 4 is given a score of −1. But, since the response to item 6 was consistent with the incorrect response to Item 4 (i.e. Item 6 was answered incorrectly by the student), item 4 is given a score of +1. Thus, the combined total for item 4 for this student for this path is 0, because −1+1=0.

The values for a given item are then summed across all the paths through that item and then divided by the number of nodes assigned a value in that path (yielding a value between +1 and −1).

These values are divided by 2, and 0.50 is added to yield a probability of correct placement in the structure between 0 and 1. Values below 0.50 were considered to be in question. The maximum value possible was dependent on the probability of guessing, and must therefore be less than 1.

Should a plurality of the items associated with a particular node exhibit consistent behavior, and that behavior is inconsistent with their place in the network, e.g., most of the items associated with a particular node exhibit below 0.50 correctness, then we may reasonably assume that the node is incorrectly located in the network.

Node definitions may need to be split when items associated with a node can be divided into one or more sets of consistently behaving items, but when all of the items associated with a node do not appear to behave consistently with respect to the network. For example, in FIG. 21, when this analysis was performed, the two items associated with H1 and the two items associated with H2 were associated with one node (H). These four items behaved inconsistently with respect to one another. It was determined that if node H were to be split into two nodes H1 and H2, each with two items, then the items associated with each of these new nodes would behave consistently with respect to each other. Nodes H1 and H2 were created and expert opinion was used to determine the targets of the new nodes. The items associated with H2 required long division, whereas the items associated with H1 required division with no remainder.

To determine an item's reliability as evidence, items (item, items stimulus-response pairs, distractors, partially correct, score points or ranges, or answer patterns that are evaluated can be treated as items in this analysis, for simplicity “item” is used here to mean any of these) are assessed for their accuracy and precision in assessing the nodes of the map. Preferably, the validity (accuracy and precision) of each item is assessed against two factors: how well it performs with respect to other items in the same node for each student, and how well it performs with respect to other nodes in the same paths as the item.

To determine the performance of items relative to each other, the consistency of performance of an item is compared on a student-by-student basis. The accuracy and precision of the items are calculated based on how consistent they are in predicting the “knows” or “doesn't know” value of the node. If the items predict consistent values, then the items are assumed to be accurately and precisely targeting the node. If two or more items predict inconsistent values with respect to one another, then either the node is poorly defined or one or more of the items is not accurately and precisely assessing the node. To determine whether it is a node definition problem or an item problem, further analysis of the items must be done.

The relative path accuracy of the items may be calculated by comparing the values of probability of correctness of placement of the node in the network structure for items within a node. The percentage values were obtained by subtracting the item's value from the value of the item with the most difference from that item and then dividing by the maximum value.

For example for node LT1 in FIG. 6, the placement probability of node LT1 for item 1 in the network was compared to the placement probability of node LT1 for item 2. The closer the probabilities of correct placement are to each other for items within a node the more likely the items were targeted correctly to the node. Conversely the more different the node placement probabilities are for items in the same node the more likely it is that one or more of the items are not correctly targeted to the node, or that the node is incorrectly defined.

If revising set membership of the item within the node structure will correct inconsistencies in both consistent prediction by items of the values for the nodes as well as precursor/postcursor predictions across nodes, then the change in node structure is recommended by the system. If an item appears to be behaving randomly, both within the node, and across the node structure, the item is considered to be invalid, the reliability of the item is reduced to zero, and it is recommended for removal from the system.

For example, in the learning map example in FIG. 6, SIPA analysis of student response data identified that Items 17 and 18 consistently predicted opposite results than that of items 15 and 16 for the “knows” value of the node. Further path analysis indicated that splitting node LT5 into 2 nodes (see FIG. 8), with Item 17 and Item 18 associated with one node (LT5B), and Items 15 and Item 16 associated with the other (LT5A). When LT5A is a precursor to LT5B, both intra node and structural predictions yielded high consistency in the data. The system recommended that node LT5 be split into the two nodes accordingly. As a concrete example, in FIG. 21, when this analysis was performed, the two items associated with H1 and the two items associated with H2 were associated with one node (H). These four items behaved inconsistently with respect to one another. It was determined that if node H were to be split into two nodes H1 and H2, each with two items, then the items associated with each of these new nodes would behave consistently with respect to each other. Nodes H1 and H2 were created and expert opinion was used to determine the targets of the new nodes. The items associated with H2 required long division, whereas the items associated with H1 required division with no remainder.

Another example, is that of item 9 from FIG. 6. An evaluation of the student responses to item 9 resulted in conflicting predictions with respect to both the node and the structure. Neither proposed change to node structures associated with item 9, or association of item 9 with other nodes resulted in resolution of the contradictions. As a result, item 9 was assumed to be a poorly functioning item, so the item 9's value as evidence was reduced.

A similar technique is also used to verify the validity of the map for evidence other than item responses. Student-by-Student Evidence Path Analysis (SEPA) uses the same path traversal techniques as SIPA, but for any evidence type (or multiple evidence types) and records if evidence linked to various nodes is consistent with the prediction provided by the map structure.

Another process for verifying a learning map is to calculate the precursor/postcursor inference probabilities using process 1600 and then modify the map as necessary. For example, if an inference value for a pair of learning targets is less than some threshold (e.g., 50%), then this would indicate that the pairing is not valid and the map needs to be modified.

As discussed above, before an educator uses a learning map to make inferences about a student's knowledge, the learning map should first be assessed for its accuracy or empirically verified. It should be noted that a learning map that is accurate for a first set of students is not necessarily accurate for a second set of students. For example, a particular learning map may be accurate for a set of students that includes only males, but may be inaccurate for a set of students that includes only females. As an additional example, a learning map in a given subject area (e.g., math) that targets learning disabled students may be different than a learning map in the same subject area that targets gifted students.

Accordingly, the present invention contemplates having multiple learning maps, with each of the learning maps targeting a different group of students. In assessing whether a particular learning map is accurate, one must first determine the subset of students that the map is intended to target and then use data gathered from assessments given to students in the subset to verify the learning map, as opposed to using data gathered from all students. Thus, in some embodiments, a SME may (1) create a first learning map in a given subject area for a first group of students (e.g., boys), (2) create a second learning map in the given subject area for a second group of students (e.g., girls), (3) verify the accuracy of the first learning map by using only data associated with students who are members of the first group, (4) verify the accuracy of the second learning map by using only data associated with students who are members of the second group, (5) use the first learning map to evaluate the knowledge state of a student in the first group and (6) use the second learning map to evaluate the knowledge state of a student in the second group. It should also be noted, that some students may be in more than one group. In other words, students might be mapped to more than one learning map. For example a student who is gifted and female might be mapped to both a map based on a gifted population and a map based on a female population.

Description of a Student Evaluation System

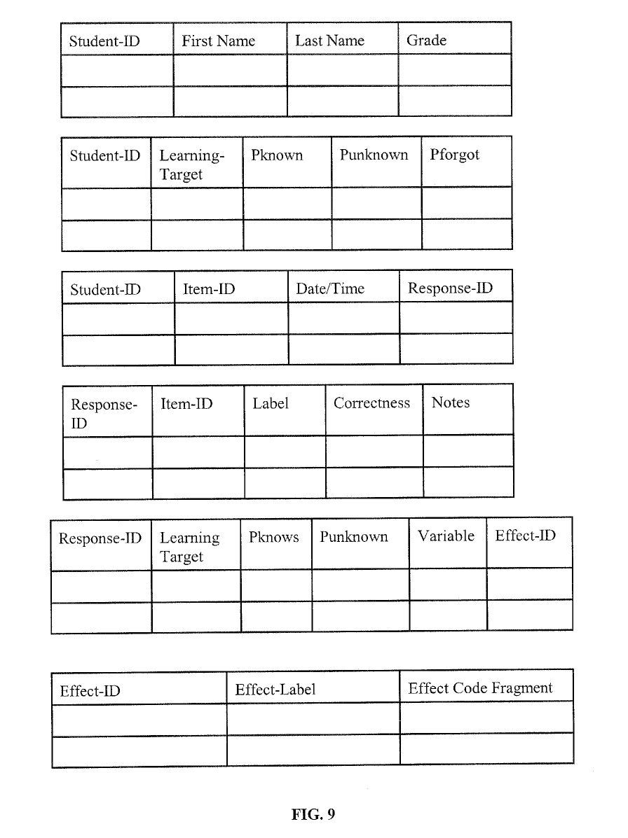

Once a learning map has been verified, the learning map may be used in conjunction with a student evaluation system. FIG. 9 illustrates database tables that may used by the student evaluation system. Other database tables may be used in addition to or instead of the ones illustrated, as the invention is not limited to any particular data model.

As shown in FIG. 9, the student evaluation system, according to one embodiment, includes the following database elements: a student table 902, a student/learning target table 904, a student test response table 906, a responses table 908, a response effects table 910, and an effects table 912. Although the database elements shown in FIG. 9 are tables from a relational database, other database elements are contemplated, such as records in a network database and other database elements.

Student table 902 is used to store information about each student in a group, such as, for example, each student's name. The student/learning target table 904 is used to store information concerning the probability that the student knows (pknown), doesn't know (punknown), and/or forgot (pforgot) the learning targets that are in the learning map. The student test responses table 906 is used for storing the students' responses to items. The response effects table 910 is a table that associates a probability value or values with a learning target/item response pair. For example, for a given 2-tuple consisting of a learning target and an item response, the table 910 associates a particular set of one or more probability values with the given 2-tuple. The effect table 912 is used to associate a code fragment with an effect.

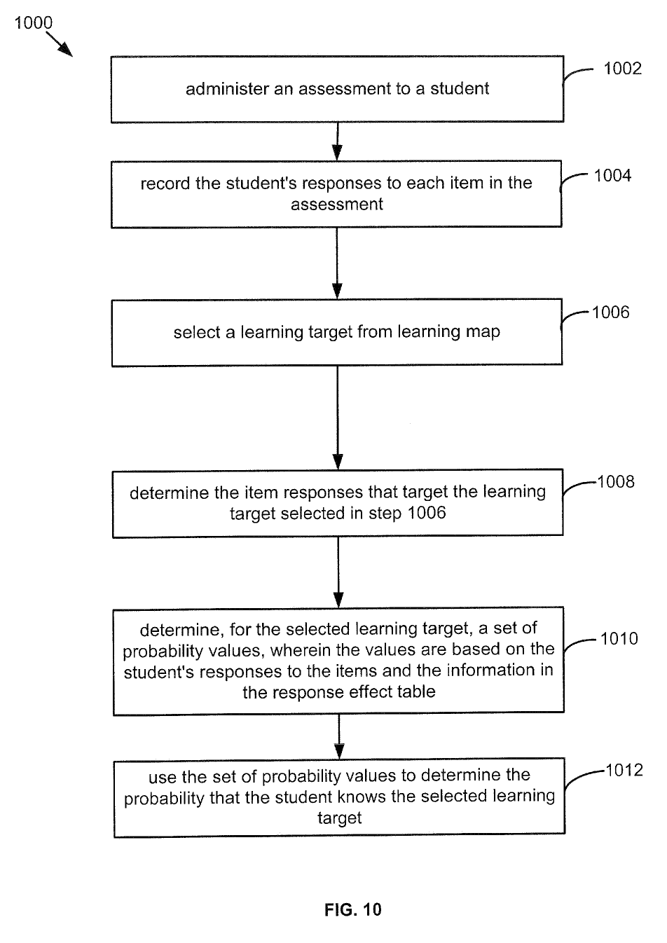

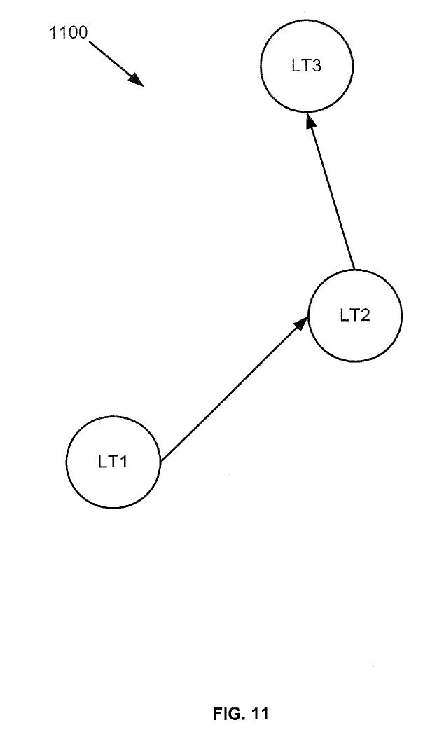

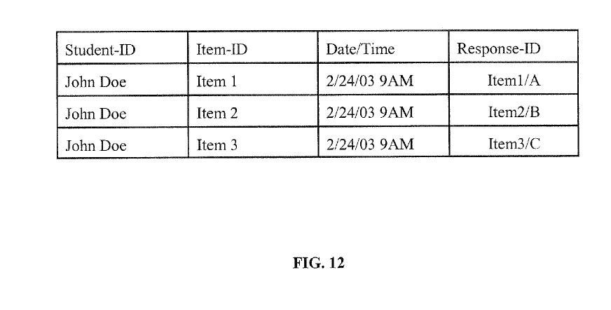

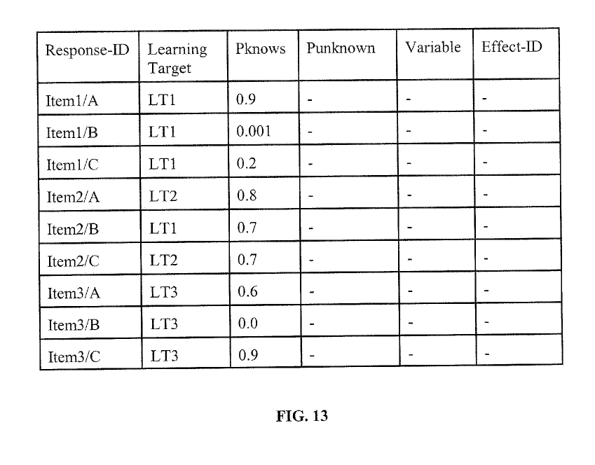

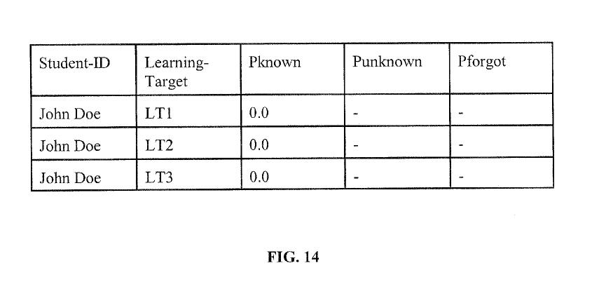

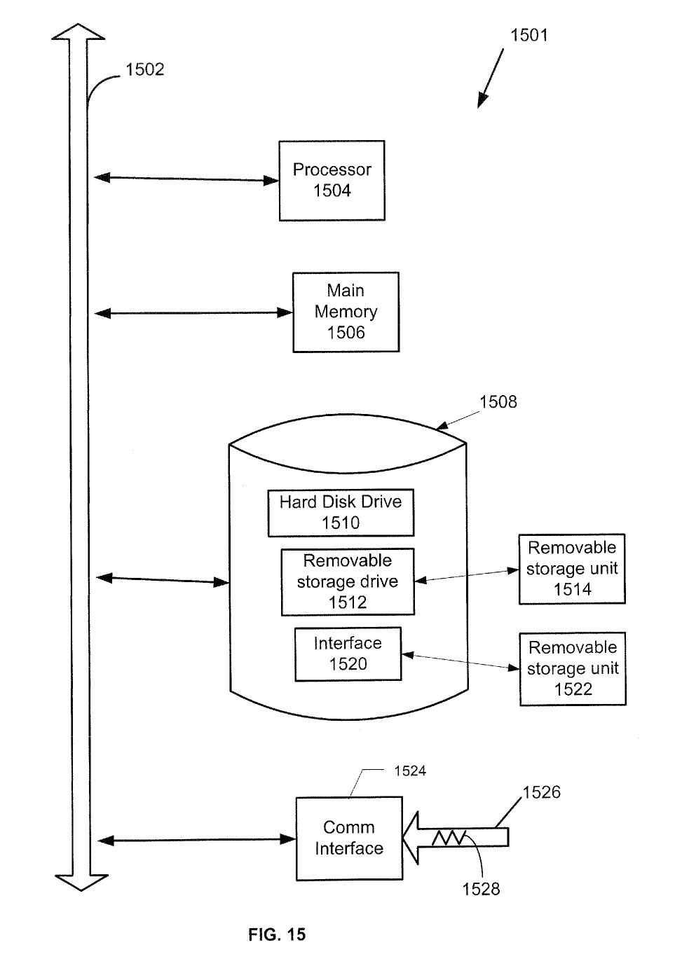

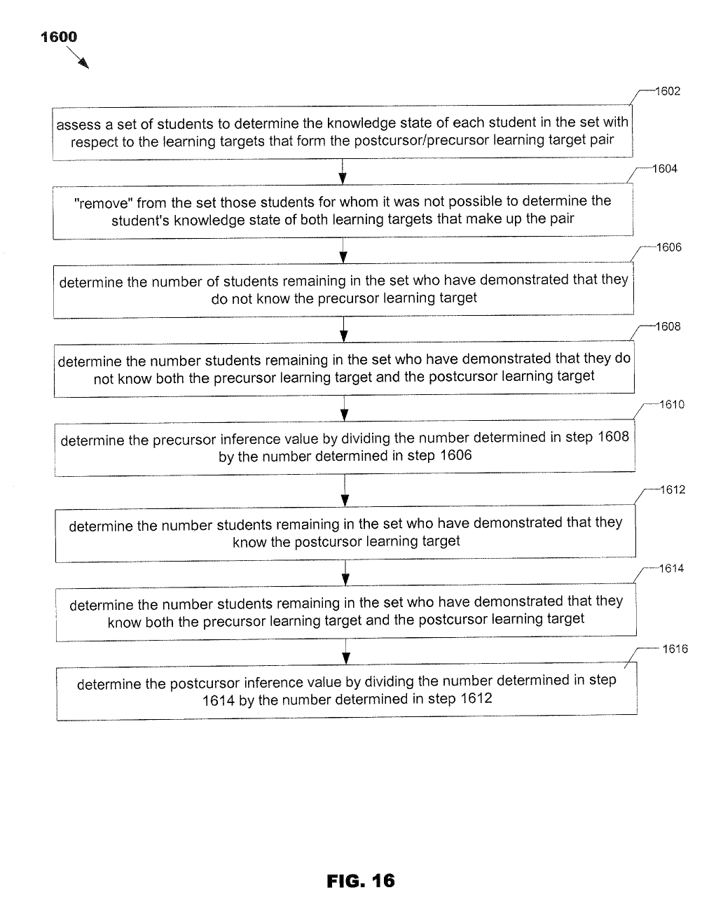

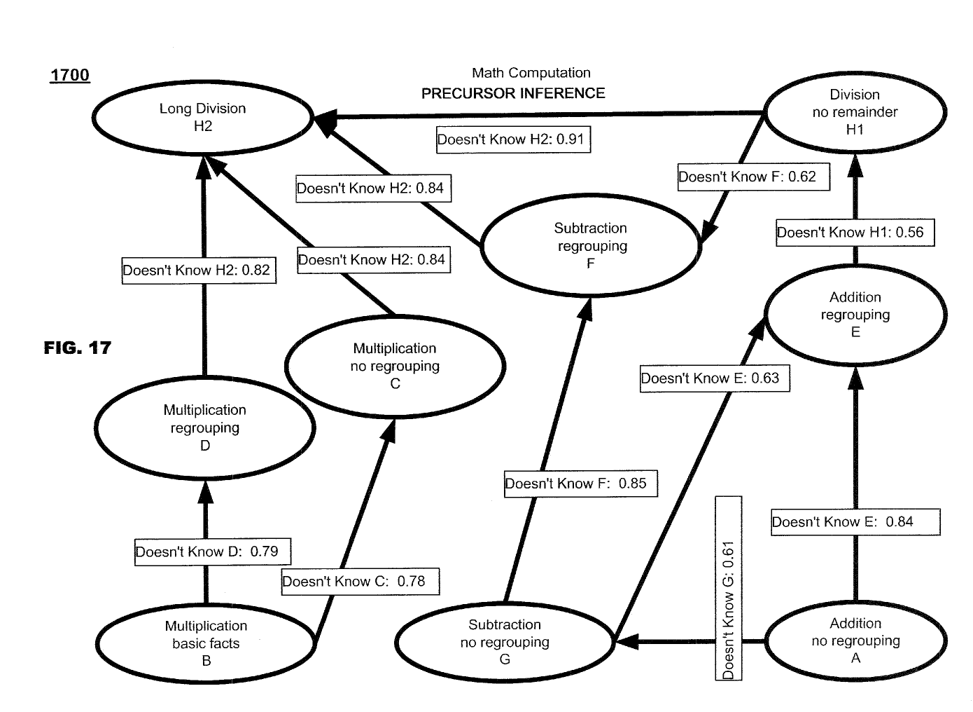

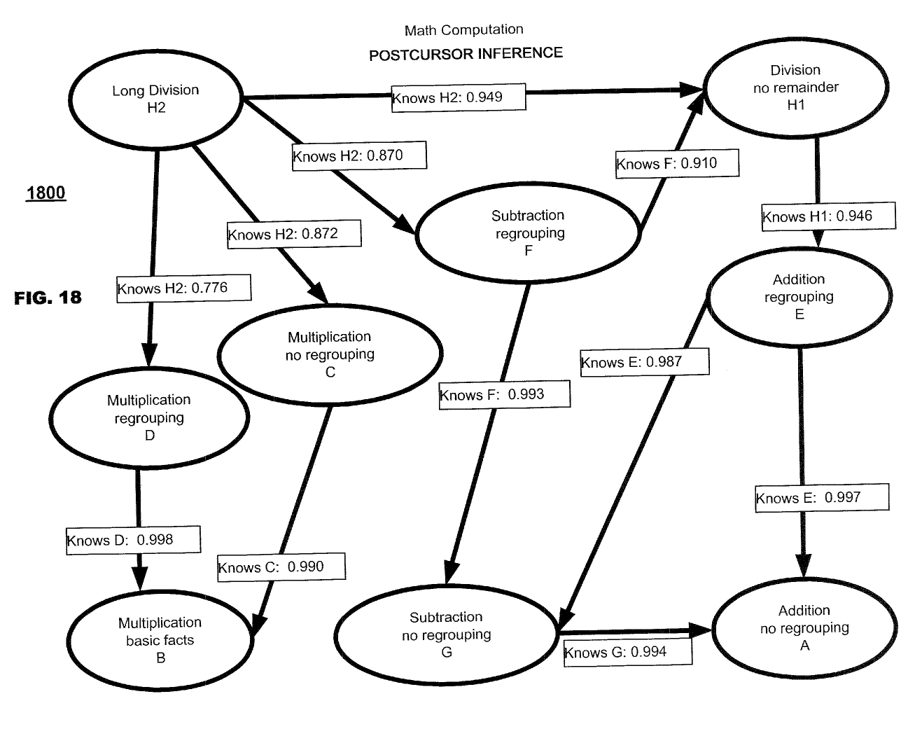

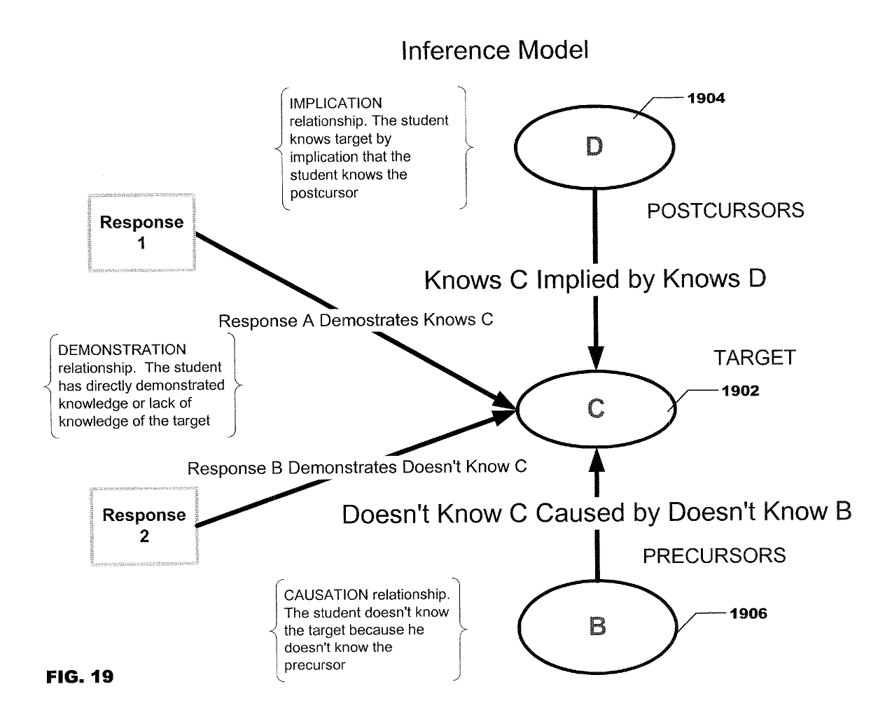

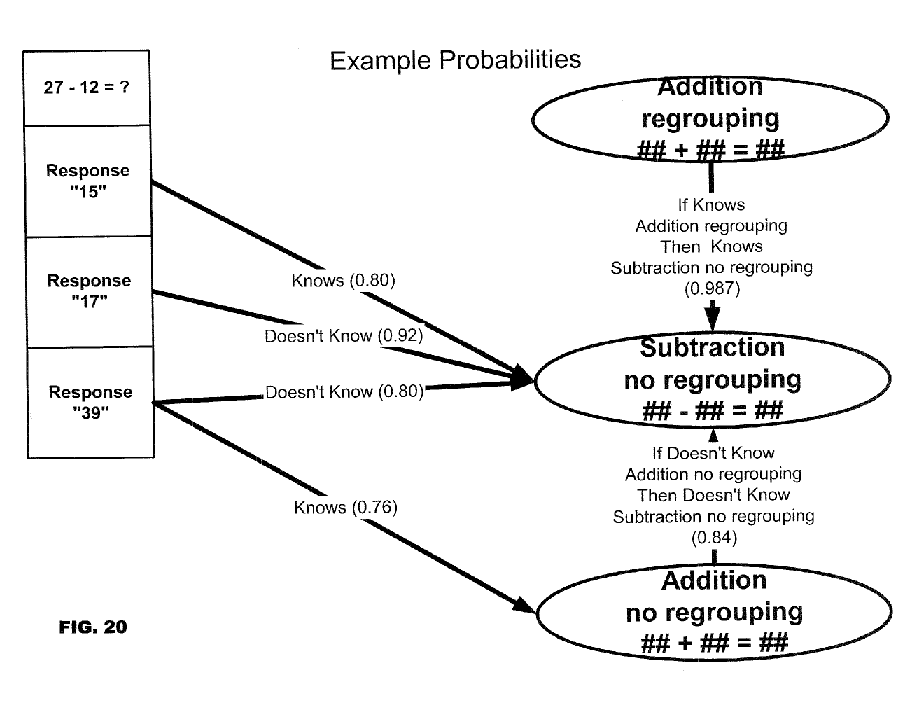

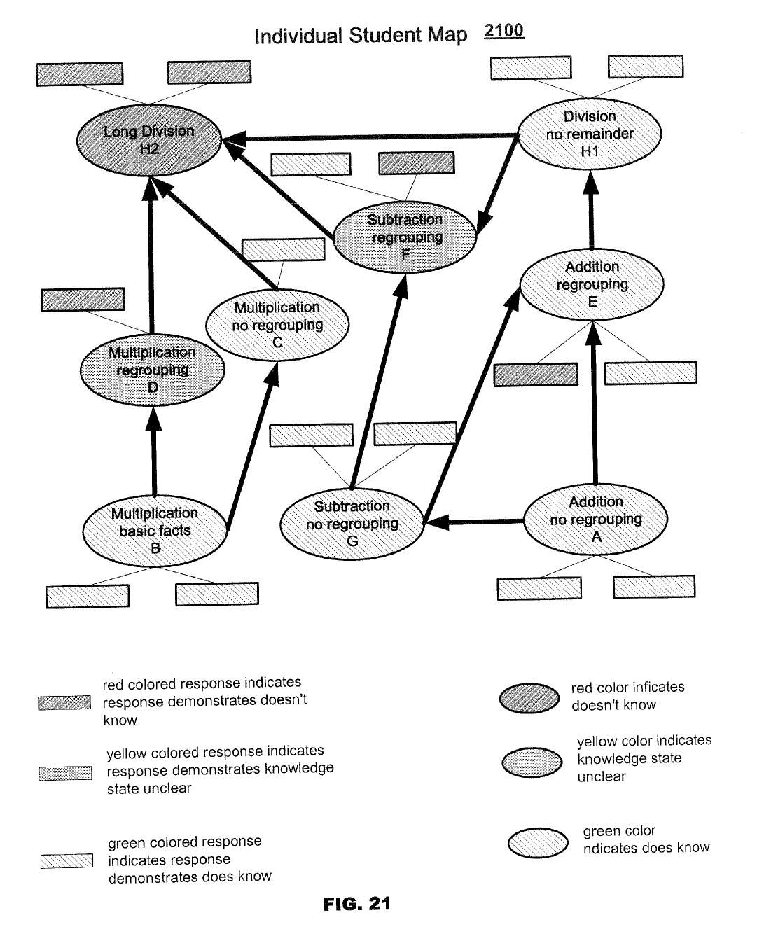

FIG. 10 illustrates a process 1000, according to one embodiment of the invention that is performed by the student evaluation system. Process 1000 may begin at step 1002, where the evaluation system administers an assessment to a student. For the sake of illustration, we will assume the assessment includes three items, wherein each item is a multiple choice question that has three possible responses (e.g., A, B, and C) and that the assessment targets the learning targets shown in FIG. 11.

In step 1004, the evaluation system stores in the student test responses table 906 the student's responses to each item in the assessment. FIG. 12 illustrates what the student test responses table 906 may look like after the evaluation system performs step 1004. As FIG. 12 indicates, for this example, the student chose response A for item 1, response B for item 2, and response C for item 3.

In step 1006, the evaluation system selects a learning target from learning map 1100 and then determines the probability that the student knows the learning target by performing steps 1008-1012.

The determination of whether a student knows the learning target is based initially on the student's responses to the items in the assessment and the information stored in the response effects table.

In step 1008, the evaluation system determines the item responses that target the learning target selected in step 1006 by examining the response effects table 910. For example, the response effects table shown in FIG. 13 indicates that responses A, B, and C of item 1 and response B of item 2 target learning target LT1, responses A and C of item 2 target learning target LT2, and responses A, B, and C of item 3 target learning target LT3.

In step 1010, the evaluation system determines, for the selected learning target and based on the student's responses to the items and the information in the response effect table, a set of probability values, which will be used to determine a probability that the student knows the selected learning target. For example, if we assume that learning target LT1 of FIG. 11 is the presently selected learning target, then the set of probability values determined in step 1010 by the evaluation system consists of the following values: 0.9 and 0.7. This is the determined set of values because the student selected response A for item 1 and response B for item 2, and, as seen from the response effect table shown in FIG. 13, a response of A to item 1 corresponds to a 0.9 probability that the student knows learning target LT1 and a response of B to item 2 corresponds to a 0.7 probability that the student knows learning target LT1.

In step 1012, the evaluation system uses the set of probability values to determine the initial probability that the student knows the selected learning target. That is, the probability that the student knows the selected learning target is a function of the set of probability values determined in step 1010. Represented mathematically, Pknows=F(p1, p2, . . . , pn), where Pknows is the probability that the student knows the selected learning target, p1 . . . pN are the probability values determined in step 1010, and f( ) is some mathematical function. In one embodiment, Pknows=Average (p1, p2, . . . , pN). In another embodiment, Pknows=Max (p1, p2, . . . , pN). Other functions, of course, could be used.

Steps 1006-1012 can be repeated for the other learning targets (LT2 and LT3) in the map shown in FIG. 11.

The probability value of a given's student's knowledge of a selected learning target can be determined by the evaluation system even if there is no direct evidence. The evaluation system can accomplish this by looking at time passed since the knowledge state encapsulated in the selected learning target was demonstrated as well as the values available in precursor or postcursor learning targets associated with the selected learning target and the time elapsed since these values were obtained.

The closer the “knows” value for the postcursors is to 1.0, the more likely it is that the student “knows” the selected learning target. In addition, the closer the “doesn't know” value for the precursors is to 1.0, the more likely it is that the student “doesn't know” the selected target. Thus, the initial probability value determined through process 1000 for a given learning target can be modified based on an evaluation of the probability values assigned to the student for the given learning target's precursor and postcursor nodes.

As a further feature, the evaluation system can determine whether the student “knew, but forgot” the selected learning target because whether the student “knew, but forgot” the selected learning target is, in part, a function of time elapsed since the student demonstrated the knowledge state encapsulated in the node and a pattern of “doesn't know” values for the selected learning target and/or precursor and postcursor nodes suggesting that the target knowledge may have been forgotten.

Additionally, the learning map can be used by the evaluation system to determine the likelihood that the student guessed (or cheated to obtain) the correct response to an item. As with traditional item response theory (IRT), the likelihood of a student providing a correct response to an item by guessing decreases with the student's ability. Increased ability is inferred by the evaluation system when the student “knows” both the precursors and postcursors to the target node. Decreased ability, and therefore increased likelihood of guessing, is inferred when the student “doesn't know” the precursors. The guessing factor can be adjusted up or down accordingly, based on student performance.

The likelihood that the student misunderstood a given item associated with a learning target but still possesses the knowledge encapsulated by the learning target is increased when the postcursors are “known”. In this way, successful demonstration of the knowledge states of postcursor learning targets provides a basis for increasing the “knows” value of a learning target beyond the value implied by a less than perfect score on the items linked to the learning target.

As a further feature, the student evaluation system can be used to implement an adaptive testing system for creating adaptive tests for testing a student's knowledge. An adaptive testing system can make us of, in particular, the student/learning target table 904 and a learning map to create an adaptive test. For example, consider the path 1100 (see FIG. 11), which may be a portion of a larger learning map) and the student/learning target table 1400 shown in FIG. 14. An adaptive testing system can use the pre/postcursor information contained in path 1400 and the information in table 1400 to create an adaptive test.

For instance, the information contained in table 1400 indicates that student, John Doe, does not know any of the learning targets in path 1100. In one embodiment, with this information, the adaptive testing system is programmed to give Joe items that test Joe's knowledge of learning target LT2. In other words, even though table 1100 indicates John does not know learning target LT1 (the first learning target in path 1100), the adaptive testing system skips that node and tests John's knowledge of LT2. In short, it is beneficial to skip at least one (1) learning target in a path. This is due to inference value of the postcursor/precursor relationship defined in the path 1100. Such a strategy of skipping one or more learning targets in a path can facilitate a significant decrease in the number of items required to gain a high probability of the student's knowledge patterns. Evidence that a particular learning target has been taught to that student can be utilized as inferential evidence that the student “knows” the learning target for the purposes of directing an adaptive test, but is not necessarily used for reporting a student's knowledge level.

In one embodiment, a student's learning map state is maintained longitudinally across assessment administrations to allow the student evaluation system to retain an understanding of the student's abilities. Information on median times to forget material and the likelihood of knowing the material given a certain elapsed time can be maintained. All of these probabilities are considered in choosing the starting place for the next assessment administration. For the purposes of reporting student knowledge, the fact that a student suddenly obtains a state of “knows” or “knew, but forgot” is considered, so if there is conflicting evidence between a current administration and a previous one, the previous evidence is not considered and the current considered authoritative. If the current evidence supports the previous evidence, then both are considered in reporting. The student view of the learning map retains information on the knowledge state of the student, as well as how long it took to gain the knowledge state, what paths through the network the student took to gain the knowledge, etc.

When determining if a student “knows”/“doesn't know” a learning target, the student evaluation system takes into account the reliability of the evidence. If the evidence is a stem-response pair, then the reliability of the stem-response is used to weigh the value of the evidence, e.g. if a student has two stem-response pairs that provide evidence, then the stem-response pair with the higher reliability will carry a relatively higher weight in the evaluation of the evidence. The values of reliability of evidence, whether it be from items, a community process, teacher evaluation, performance appraisal, etc, is updated by the system as new information becomes available, and/or at set points in time as desired. For reporting purposes a simple “student knows” or “student doesn't know” response can be returned by the evaluation system, once reliability ranges have been set for a given set of students. This allows for the possibility that individual states or districts or other users of the system may want to have different acceptability parameters for reliability of the returned values. Individual users can also specify minimum evidence requirements, e.g., minimum of two items per learning target, or minimum of two pieces of evidence whether item or teacher evaluation, etc. Parameters can be set for minimum values of any of the evidence that the system can obtain. If the number of items needed to meet evidentiary limits for a given student is not available, the system keeps track of how often this occurs and may automatically signal an “insufficient items” alert. This alert may be used to request new item/response development. For that student, if possible, it then uses items from surrounding nodes to “make up the difference” in inferential evidence. The same method can be used to request other evidence such as teacher evaluations etc, when the evidentiary limit is not yet achieved for a given student.

Referring now to FIG. 21, FIG. 21 illustrates an example individual student map 2100 produced by a student evaluation system according to the present invention. The individual student map 2100 may be created and displayed by the evaluation system after a student's knowledge state has been assessed as described above. As shown in FIG. 21, map 2100 is a color-coded learning map for an individual student. Map 2100 shows not only learning targets, but also items associated with those learning targets. The learning targets are represented as ovals and the items are represented as rectangles.

Each learning target in the map is given a color depending on the assessed knowledge state of the student with respect to the learning target. For example, if the student evaluation system determines that the student knows a particular learning target, then that target will be colored green. If the student evaluation system determines that the student does not know a particular learning target, then that target will be colored red. And if the student evaluation system is unable to determine whether the student knows or doesn't know a particular learning target, then that target will be colored yellow.

In addition to each learning target having a particular color, each item associated with a learning target is also colored. The color given to an item is dependent on the student's response to the item. For example, an item is colored red if the student's response to the item indicates that the student doesn't know the learning target with which the item is associated, an item is colored green if the student's response to the item indicates that the student knows the learning target with which the item is associated, and an item is colored yellow if the student's response to the item indicates the student's knowledge state of the learning target with which the item is associated is unclear.

Educators will find map 2100 to be a useful tool in evaluating a student. Simply by glancing at the map 2100, a teacher can quickly determine the learning targets that the student knows and doesn't know. The teacher can then help focus the student in those areas were the student's skill appear to be lacking. It is expected that a teacher using the evaluation system will have the system create an individual student map for each student in the teacher's class. This will enable the teacher to give more individualized instruction to each student, because, simply by reviewing each students' learning map, the teacher can quickly determine the areas that need to be focused on for each student. For example, map 2100 indicates that the student should focus on three learning targets: (D) multiplication regrouping; (F) subtraction regrouping; and (H2) long division. Another individual student map may indicate that another student need only focus on learning division. In this way, the individual student maps provide a powerful tool to educators.

Pattern comparisons:

The learning maps of the present invention may also be used as a basis for various pattern comparisons, e.g. various comparative scales could be linked to individual learning targets or specific collections of learning targets within a map. For example, an individual learning target could have an 84.6% probability that students at grade 5, 16th instructional week in the United States national population have mastered the learning target. Similarly customer-specific, instructional material-specific, and other probabilities can be developed. Analytical and community process techniques can be applied to discover the identity of learning targets and/or items (some of which might not be mapped to learning targets) that collectively may be grouped together for the purpose of providing statistically valid comparative or normative scores. These pattern comparison techniques could also be used for establishing of a type of “grade-equivalent”, national percentile, or normative curve equivalent score, or other types of comparative scores, such as comparisons to latent traits or ability scores, etc. The comparative or normative population could be global, national, or within any institutional unit at any level (e.g., a school district), and optionally based on any number of sub-population selections including grade, demographics, learning style categorization, etc.

Learning map patterns developed for each set of students (e.g., state, district, special needs category, user types, etc) can also be used to perform gap analyses. One example would be for a student moving from one state to another; the receiving district could examine the two states' learning progress maps to discover potential learning gaps based on differences between each state's specific network, and target assessment and remedial or advanced instructional activities based on the gaps or differences. Another service could be for an institution to do “what if” analyses on the impact (learning time, etc.) of potential changes to their curriculum frameworks.

Community Involvement and Adapting the Leaning Map

It is a fact that new knowledge is discovered on a regular basis and theories previously thought to valid will occasionally be discovered to be misconceptions. As a result of these transitions in knowledge the system, through its longitudinal tracking of students/users, is able to send updates to users of the system when previously “known” information changes or becomes invalidated by current theory. In this way users of the system can be informed of changes that need to be made in their own knowledge as a result of information provided to the system through a community process.

For example, biology is a rapidly changing field as new discoveries about the human genome are made on an almost weekly basis, as these new discoveries become recognized by the scientific community they can be integrated in as changes to the underlying learning progress map network, and all users of the system can be notified of the changes, and the new knowledge that they need to acquire (including links to instructional materials, should the system have them).

It is also possible that entirely new branches of a learning map may come into being or need to be changed for a given set of students, for example entire map sections might need to be relocated based on external events. For example, if a country converts from English measures to the metric system, then strands covering the metric system may need to be added to a map, and then at some point the strands (i.e., learning target paths) that involve English unit to metric conversions might need to be relocated in a curriculum framework, emphasis changed, or obsoleted altogether.

### CONCLUSION

A system that can create and adapt a learning map over time directly as a result of the performance of students on tests and indirectly to variables affecting student performance, such as changes in knowledge, curriculum, and instruction in each content area, has powerful implications for the field of education. By being capable of defining and continually updating precursor-postcursor relationships across all learning targets the system permits diagnostic/prescriptive products linked to a map to generate for each student a comprehensive individual educational plan based on both an integrated, accurate view of the student's knowledge states across all content areas for which the map has either direct or inferential evidence, and matching of the student's data to the typical data pattern of one or more user subgroups (cognitive, emotional, behavioral, cultural, and linguistic), adding to the diagnostic/prescriptive report all the knowledge stored in and outside the system about the special needs of this subgroup (this is in addition to all the node-specific prescriptive links in each strand and content area highlighted as appropriate for this individual as a result of the diagnosis).

The very granular, cognitively organized, node-based organization of the learning maps permits conceptual indexing into instructional materials, web-sites, and other repositories of content useful for instructional purposes, with, wherever legally acceptable or contractually permissible, a deep linking of nodes in the framework to the associated content at the same level of specificity as described in the framework. This capability places the system potentially at the hub of a powerfully adaptive instructional system with student diagnostic and prescriptive functions automated at a level that makes possible an Individual Educational Plan for each student, enabling significant acceleration of student progress in each content area. Because the learning targets in a learning map can be coded and thereby automatically linked to any set of curriculum or assessment standards as well as the content of any set of instructional materials, a comprehensive, adaptive learning map potentially can support the instructional process in any educational system where there are well specified, attainable educational goals.

The adaptive structure of maps produced by the system also facilitates flexible, alternative structuring, compiling, and displaying of the map contents for different audiences, including teachers, parents, students, administrators at different levels of the education system, instructional materials publishers, software designers, and all disciplines interested in the organization of knowledge for learning and assessment.

The systems and methods of the present invention described herein may be implemented using a computer system or other processing system. In one embodiment, the invention is directed toward a computer system capable of carrying out some or all of functionality described above.

FIG. 15 is a block diagram of an example computer system 1501. Computer system 1501 includes at least one processor, such as processor 1504. Processor 1504 is connected to a bus 1502. Various software embodiments are described in terms of this example computer system. After reading this description, it will become apparent to a person skilled in the relevant art how to implement the invention using other computer systems.

Computer system 1502 also includes a memory 1506, preferably random access memory (RAM), and can also include a secondary memory 1508. Secondary memory 1508 can include, for example, a hard disk drive 1510 and/or a removable storage drive 1512, representing a floppy disk drive, a magnetic tape drive, an optical disk drive, etc. The removable storage drive 1512 reads from and/or writes to a removable storage unit 1514 in a well known manner. Removable storage unit 1514, represents a floppy disk, magnetic tape, optical disk, etc. which is read by and written to by removable storage drive 1512. As will be appreciated, the removable storage unit 1514 includes a computer usable storage medium having stored therein computer software and/or data.

In alternative embodiments, secondary memory 1508 may include other similar means for allowing computer programs or other instructions to be loaded into computer system 1501. Such means can include, for example, a removable storage unit 1522 and an interface 1520. Examples of such can include a program cartridge and cartridge interface (such as that found in video game devices), a removable memory chip (such as an EPROM, or PROM) and associated socket, and other removable storage units 1522 and interfaces 1520 which allow software and data to be transferred from the removable storage unit 1522 to computer system 1501.

Computer system 1501 can also include a communications interface 1524. Communications interface 1524 allows information (e.g., software, data, etc.) to be transferred between computer system 1501 and external devices. Examples of communications interface 1524 can include a modem, a network interface (such as an Ethernet card), a communications port, a PCMCIA slot and card, etc. Information transferred via communications interface 1524 are in the form of signals which can be electronic, electromagnetic, optical or other signals capable of being received by communications interface 1524. These signals 1526 are provided to communications interface via a channel 1528. This channel 1528 carries signals 1526.

In this document, the terms “computer program medium” and “computer usable medium” are used to generally refer to media such as removable storage device 1512, a hard disk installed in hard disk drive 1510, and signals 1526. These computer program products are means for providing software to computer system 1501.

Computer programs (also called computer control logic) are stored in main memory and/or secondary memory 1508. Computer programs can also be received via communications interface 1524. Such computer programs, when executed, enable the computer system 1501 to perform the features of the present invention, which have been described above. In particular, the computer programs, when executed, enable the processor 1504 to perform the features of the present invention. Accordingly, such computer programs represent controllers of the computer system 1501.

In an embodiment where the invention is implemented using software, the software may be stored in a computer program product and loaded into computer system 1501 using removable storage drive 1512, hard drive 1510 or communications interface 1524. The control logic (software), when executed by the processor 1504, causes the processor 1504 to perform the functions of the invention as described herein.

While the invention has been described in detail above, the invention is not intended to be limited to the specific embodiments as described. It is evident that those skilled in the art may now make numerous uses and modifications of and departures from the specific embodiments described herein without departing from the inventive concepts.

What is claimed is:

1. A student evaluation system comprising,
means for recording or accessing a student's response to at least one item of an assessment; and
means for determining a probability that the student knows a selected learning target in a learning map, wherein the determining means makes the determination using, at the least, a response from the student to an item that targets the selected learning target and a probability value associated with the response and the selected learning target.

2. The student evaluation system of claim 1, further comprising means for creating an individual student map for a student.

3. The student evaluation system of claim 2, wherein the individual student map comprises a plurality of learning targets.

4. The student evaluation system of claim 3, further comprising means for determining the student's knowledge state with respect to each of said plurality of learning targets.

5. The student evaluation system of claim 4, wherein each of said learning targets has a color, and the color of a learning target is a function of the student's knowledge state with respect to the learning target.

6. A student evaluation method, comprising:
administering an assessment to a student, wherein the assessment comprises a plurality of items;
recording or accessing the student's response to at least one item in the assessment;
selecting a first learning target from a learning map;
determining, for the first learning target, a set of values, wherein the values are based on the student's responses to the items and predetermined response effect values; and
determining a probability value that represents the probability that the student knows the first learning target, wherein the determined probability value is a function of, at the least, said set of determined values.

7. The method of claim 6, further comprising the step determining the postcursors of the first learning target.

8. The method of claim 7, further comprising the step of, for each postcursor, determining the probability that the student knows the postcursor.

9. The method of claim 8, further comprising the step of determining whether the student's demonstrated knowledge state of the postcursors indicates that the student's actual probability of knowing the learning target is greater than the determined probability value.

10. The method of claim 9, further comprising the step of increasing the probability value if the student's demonstrated knowledge state of the postcursors indicates that the student's actual probability of knowing the learning target is greater than the determined probability value.

11. The method of claim 6, further comprising the step determining the precursors of the first learning target.

12. The method of claim 11, further comprising the step of, for each precursor, determining the probability that the student knows the precursor.

13. The method of claim 12, further comprising the step of determining whether the student's demonstrated knowledge state of the precursors indicates that the student's actual probability of knowing the learning target is less than the determined probability value.

14. The method of claim 13, further comprising the step of decreasing the probability value if the student's demonstrated knowledge state of the precursors indicates that the student's actual probability of knowing the learning target is less than the determined probability value.

15. A student evaluation method, comprising:
at a first point in time, assessing a student's knowledge state with respect to at least one learning target;
determining a first probability value based on data collected during the assessing step, wherein the first probability value represents a probability that the student has mastered the at least one learning target;
at a second point in time, assessing the student's knowledge state with respect to the at least one learning target;
determining a second probability value based on data collected during the second assessing step, wherein the second probability value represents a probability that the student has mastered the at least one learning target;
determining the amount of time that has elapsed between the first point in time and the second point in time;
determining whether the student knew the at least one learning target at the first point in time but forgot it by the second point in time, wherein said determination is based, at least in part, on the determined amount of time that has elapsed, the first probability value, and the second probability value.

16. The student evaluation method of claim 15, further comprising the step of, at the first point in time, assessing the student's knowledge state with respect to a postcursor of the learning target.

17. The student evaluation method of claim 16, wherein said determination is based, at least in part, on the determined amount of time that has elapsed, the first probability value, the student's knowledge state of the postcursor at the first point in time, and the second probability value.

18. The student evaluation method of claim 15, further comprising the step of, at the second point in time, assessing the student's knowledge state with respect to a precursor of the learning target.

19. The student evaluation method of claim 18, wherein said determination is based, at least in part, on the determined amount of time that has elapsed, the first probability value, the student's knowledge state of the precursor at the second point in time, and the second probability value.

20. A method, comprising:
creating a first learning map in a given subject area for a first group of students,
creating a second learning map in the given subject area for a second group of students,
verifying the accuracy of the first learning map by using data associated with only students who are members of the first group,
verifying the accuracy of the second learning map by using data associated with only students who are members of the second group,
using the first learning map to evaluate the knowledge state of a student in the first group; and using
the second learning map to evaluate the knowledge state of a student in the second group.
